(19) United States
(12) Patent Application Publication
(10) Pub. No.: US 2005/0097558 A1
(43) Pub. Date: May 5, 2005

(54) System and method for a symmetric architecture for multimedia players

(76) Inventor: Jeremy S. de Bonet, North Andover, MA (US)

Correspondence Address: Sprinkle IP Law Group, P.O. Box 684767, Austin, TX, 78768-4767, US

(21) Appl. No.: 10/975,274

(22) Filed: Oct. 28, 2004

Related U.S. Application Data
(60) Provisional application No. 60/516,437, filed on Oct. 31, 2003.

(51) Int. Cl. G06F 9/46

(52) U.S. Cl. 718/102

(57) ABSTRACT

Systems and methods for architectures for a compact and efficient multimedia player are disclosed. These architectures may consist of two threads which operate in parallel to read data over a network and render this data for a user of the multimedia player. Both threads are operable to perform read operations and render operations, however, the two threads do not simultaneously read or render data. The two threads may be kept out of phase via thread synchronization techniques, thus when one thread is reading the other may be rendering and vice versa. If one thread finishes its current phase before the other thread has completed its current phase, then the first thread blocks until the second thread completes its current phase; the threads can then exchange tasks.

### RELATED APPLICATIONS

This application claims a benefit of priority under 35 U.S.C. § 119 to the filing date of, U.S. Provisional Patent Application Ser. No. 60/516,437 by inventor Jeremy S. de Bonet, entitled “Symmetric Reader-Render Architecture System and Method for Multimedia Players” filed on Oct. 31, 2003, the entire contents of which are hereby expressly incorporated by reference for all purposes.

This application is related to, U.S. patent application Ser. Nos. 10/342,113 by inventors Jeremy S. de Bonet and Todd Stiers, entitled “Network Proxy Platform that Simultaneously Supports Data Transformation, Storage, and Manipulation for Multiple Protocols” filed on Jan. 14, 2003; 10/347,138 by inventor Jeremy S. de Bonet, entitled “Method for Isolating and Protecting Software Components to Increase Reliability and Prevent Inadvertent Corruption” filed on Jan. 17, 2003; 10/345,101 by inventors Jeremy S. de Bonet, Todd Stiers and Jeffrey R. Annison entitled “Method and System of Accessing Shared Resources Using Configurable Management Information” filed on Jan. 15, 2003; 10/345,067 by inventors Jeremy S. de Bonet entitled “Method and System of Protecting Shared Resources Across Multiple Threads” filed on Jan. 15, 2003; 10/664,246 by inventors Jeremy S. de Bonet, Todd Stiers, Phillip Alvelda and Jeffrey R. Annison entitled “System and Method for the Packaging and Distribution of Data” filed on Sep. 17, 2003; __/______ by inventor Jeremy S. de Bonet, entitled “System and Method for a Synchronized Shared Buffer Architecture for Multimedia Players” filed on Oct. 28, 2004 (ATTY. DOCKET NUMBER IDET1150-1) and __/______ by inventors Jeremy S. de Bonet and Hanqing Liao, entitled “System and Method for a Data Format for Command Encapsulation” filed on Oct. 28, 2004 (ATTY. DOCKET NUMBER IDET1130-1); the entire contents of which are hereby expressly incorporated by reference for all purposes the entire contents of which are hereby expressly incorporated by reference for all purposes.

### TECHNICAL FIELD OF THE INVENTION

The invention relates in general to multimedia players, and more particularly, to methods and systems for compact and efficient architectures for multimedia players.

### BACKGROUND OF THE INVENTION

The use of computer networks to store data and provide information to users is increasingly common. A microcosm of this phenomenon can be seen in the prevalence of the internet. The internet is used to distribute a wide variety of content to users, including video, audio, text, images etc. Each of these types of content may, in turn, be distributed in a wide variety of formats. These various types of content may be themselves packaged in a variety of payload formats and delivered via a whole host of application and transmission protocols.

In most cases, a user at a client computer wishes to access a certain piece of data and makes a request to a server computer for that piece of data. The server computer encapsulates the requested data in a set of packages for delivery to the client computer. The encapsulation methodology used by the server depends on the variables mentioned above, the type of content, the format of that content, the format of the payload, the application and transmission protocols being used to send the data etc. Upon receiving a package, the client computer must peel back the layers of the raw data received to ascertain the content and payload format used to package the data so the data may be processed and rendered correctly.

In most cases, the tasks of deciphering, decoding, and rendering the received data falls to a multimedia player residing on the client computer, such as Microsoft Media Player, RealPlayer or Quick Time. Typically, these multimedia players receive data over the network, store this data to a buffer, and render data from this buffer.

In most cases, the type of buffer utilized is a ring buffer with a read and write pointer. The multimedia player receives data and writes this data to the location pointed to by the write pointer. Similarly, the multimedia player reads data from the location indicated by the read pointer and renders this data. Occasionally, however, the read and write pointer may point to the same location. This situation indicates that the buffer is full and no more data can be written to the buffer without overwriting previously stored data. Conversely, this situation may also indicate that the buffer is empty and no more data can be read from the buffer. In either of these cases, the multimedia player must block until either data is written to the buffer or read from the buffer. Not only does this slow the execution and operation of the multimedia player but, additionally, to synchronize read and write operations to the buffer and to check and maintain separate read and write pointers, requires a significant amount of overhead.

When performing these tasks on a workstation or desktop environment, these issues are not so problematic. Most workstations or desktop computers have fast enough processors and large enough memories to accommodate the multimedia players with little difficulty. In a mobile environment, however, these issues may become problematic. Cellular telephones, PDAs, mobile computers etc. simply do not have the processing power or space to be able to efficiently evaluate and render raw multimedia data using conventional multimedia players.

The ability of these mobile devices has not however quenched the thirst of their users for data of this type. In fact, the increasing prevalence of these types of mobile devices has only increased the demand for multimedia data in a mobile environment.

Typically, to distribute multimedia data to mobile devices some reduction in the data rate is utilized to make the transfer, decoding and rendering of the multimedia data more efficient. This may be achieved by distributing the requested multimedia in a lower fidelity, or at a lower sampling rate. This is a non optimum solution however, a wireless device in one area may have a certain bandwidth while another device may have a much lower bandwidth (e.g. in a tunnel, or area of low reception), and the bandwidth of each device on a network may vary dynamically. These variations in bandwidth can cause the multimedia player on the mobile device to block frequently, as the buffer utilized by the multimedia player alternately fills when the bandwidth is relatively high and empties when the bandwidth is relatively low.

Thus, a need exists for a compact and efficient architecture for a multimedia player which can synchronize the writing and rendering operations of the multimedia player with a minimum of overhead.

### SUMMARY OF THE INVENTION

Systems and methods for architectures for a compact and efficient multimedia player are disclosed. These architectures may consist of two threads which operate in parallel to read data over a network and render this data for a user of the multimedia player. Both threads are operable to perform read operations and render operations, however, the two threads do not simultaneously read or render data. The two threads may be kept out of phase via thread synchronization techniques, thus when one thread is reading the other may be rendering and vice versa. If one thread finishes its current phase before the other thread has completed its current phase, then the first thread blocks until the second thread completes its current phase; the threads can then exchange tasks.

In one embodiment, a first thread and a second thread are provided, wherein each thread is operable to read data, wait to read data, render data and wait to render data; and the first thread and second thread are synchronized so that while the first thread is rendering data the second thread is reading data or waiting to render data, and while the first thread is reading data the second thread is rendering data or waiting to read data.

In one embodiment, the first thread and second thread are synchronized so that while the second thread is rendering data the first thread is reading data or waiting to render data and while the second thread is reading data the first thread is rendering data or waiting to read data.

In one embodiment, the first thread and second thread execute identical program code.

In one embodiment, each thread has a buffer, and each thread reads data to its buffer and renders data from its buffer.

In one embodiment, the first thread and second thread are synchronized with a first mutex and a second mutex.

In one embodiment, the first mutex is a read mutex and the second mutex is a render mutex.

In one embodiment, the first mutex and second mutex are globally shared by the first thread and the second thread.

In one embodiment, the first thread and second thread are synchronized with a Java “synchronized” function call.

In one embodiment, the first thread and second thread are synchronized with a semaphore.

In one embodiment, the first thread and second thread are synchronized with busy waiting.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of an exemplary system for use with embodiments of the present invention.

FIG. 2 is a flow diagram depicting the delivery of content from a content source to an intended recipient.

FIG. 3 depicts one embodiment of an architecture for requesting, receiving and displaying multimedia content at a mobile device.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

A few terms are defined or clarified to aid in understanding the descriptions that follow: a device may be any sort of apparatus which can receive and display data including mobile phones, PDAs, laptop computers and the like.

A format is a way of arranging, organizing, or representing data, usually using a defined standard such as MPEG or motion JPEG. For purposes of this application, formats will be understood to be distinct if characteristics of the represented data differ in any manner. Additionally the same standard at two different rates will be understood to mean two distinct formats. For example, high framerate motion JPEG would be a distinct format from low framerate motion JPEG.

Furthermore, augmenting a defined standard with additional information will be understood to constitute a distinct format. For example, augmenting an MPEG representation of video data with closed captioning information would be a distinct format from video data represented in the MPEG format alone. Compressed video data will also be understood as distinct from its uncompressed equivalent. For example, video data compressed with MPEG will be understood as distinct format from identical uncompressed raw video data. It will be obvious to those of ordinary skill in the art that for purposes of this application distinct formats may be created in an almost endless variety of ways, such as varying resolution, screen size, sampling rate, and the like.

A read is intended to encompass any or all portion of the acts of requesting data, receiving data, storing data or any administrative actions associated with the acts of requesting, receiving or storing, such as obtaining and releasing locks on mutexes, waiting to obtain access to buffers etc.

A render is intended to encompass any or all portion of the acts of reading data from a storage location, processing the data, and outputting the results of the processing including any administrative actions associated with the acts of reading, processing or outputting, such as obtaining and releasing locks on mutexes, waiting to obtain access to buffers etc.

A packet is intended to mean any set of data, including a set of data operable or configured for transmission.

Though the exemplary embodiment described below utilizes embodiments of the present invention in a media bridge designed to convert broadcast media such as television into a variety of formats for delivery over a wireless communication network, those skilled in the art will appreciate that these same systems and methods may be employed for a myriad number of other uses and applications, such as delivering internet content over a wireline system, or other type of network topology. Additionally, it will be understood that these same systems and methods, or any subset, can be implemented in a variety of software systems, computer programs, hardware, and any combination thereof.

Attention is now directed to systems and methods for architectures for a compact and efficient multimedia player. These architectures consist of two threads which operate in parallel to read data over a network and render this data for a user of the multimedia player. Each thread may be operable to perform four operations, waiting to read, reading, waiting to render and rendering. When a thread completes one phase it moves on to another phase, however, the two threads do not simultaneously read, or simultaneously render, data. The two threads may be kept out of phase via thread synchronization techniques, thus when one thread is reading the other thread may be rendering or waiting to read, while if a thread is rendering the other thread may be reading or waiting to render. When a thread is reading or rendering the thread will continue reading or rendering until a discrete task is completed or cancelled. Cancellation of any of these tasks can occur due to user input, network failure, application termination or other events which may occur externally to the operating thread. In some embodiments one thread could cancel the operation of another

If one thread finishes its current phase before the second thread has completed its current phase, then the first thread blocks until the second thread completes its current phase; the threads can then exchange tasks. As both threads may be implemented using the same code, they may be stored using little memory and executed with a minimum of CPU overhead, making this architecture ideal for devices with limited computational power. Additionally, client-server synchronization for data delivery is simplified, as data is requested sequentially at the same frequency it is rendered.

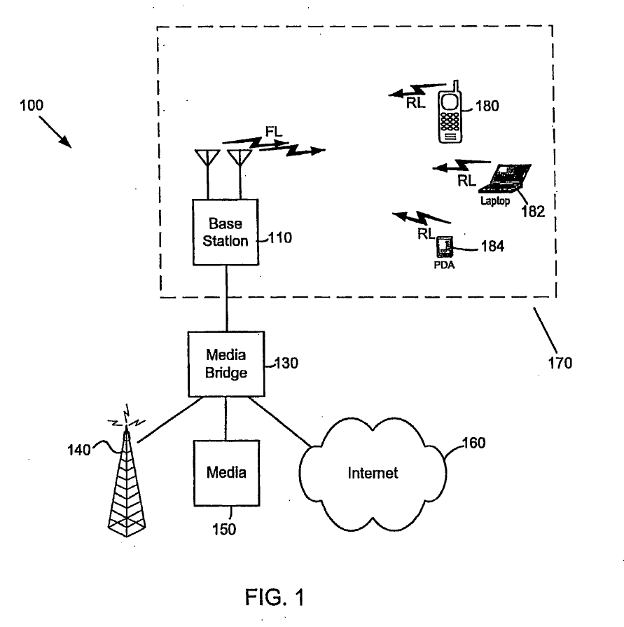

Turning now to FIG. 1, a diagram illustrating the structure of an exemplary communications system for utilization with embodiments of the present invention is shown. As depicted in this figure, this system 100 comprises a media bridge 130 for interfacing between different types of content systems 140, 150, 160 and one or more wireless (or potentially wireline) communication networks 170. Content systems 140, 150, 160 may be broadcast media such as television or radio, other audio or video data, such as a video feed from a DVD player, or the Internet.

Wireless communication network 170 is in turn composed of base station 110 that is configured to communicate with a plurality of mobile devices (devices) 180, 182, 184. Mobile devices 180, 182, 184 may, for example, be cellular telephones, laptop computers, personal information managers (PIMs or PDA), or the like that are configured for wireless communication. These devices 180, 182, 184 may be running software designed for use with embodiments of the present invention. It should be noted that these devices 180, 182, 184 need not actually be “mobile,” but may simply communicate with base station 110 via a wireline or wireless link. Base station 110 transmits data to mobile devices 180, 182, 184 via corresponding forward link (FL) channels, while mobile devices 180, 182, 184 transmit data to base station 110 via corresponding reverse link (RL) channels.

Users of mobile devices 180, 182, 184 may wish to have content from content sources 140, 150, 160 delivered to them. This may be problematic, however, as delivery of much of this content typically requires large amounts of data to be delivered over a high-reliability high- bandwidth connection. Additionally, even if wireless network 170 is such a high-bandwidth network, mobile devices 180, 182, 184 may experience temporary periods of low-bandwidth connection to base station 110, or may be incapable of handling the complexity of such content. Media bridge 130 alleviates these problems by delivering tailored content from content source 140, 150, 160 to each individual mobile device 180, 182, 184.

Media bridge 130 may encapsulate content from content sources 140, 150, 160 for delivery to mobile devices 180, 182, 184 in a data format which is compact, and simplifies the tasks of decoding and rendering the data format performed by mobile devices 180, 182, 184. Streaming content from a content source 140, 150, 160 is fed into media bridge 130, at which point media bridge 130 may capture and digitize the incoming content if the data is not already in a digital format. This digitized data may be divided up into serialized portions and converted to a wide variety of formats. This data can then be encapsulated in packets with a certain data format and a particular series of packets may be sent to base station 110 for delivery to mobile device 180, 182, 184 depending on criteria associated with that particular device 180, 182, 184. It should be noted that the mobile devices 180, 182, 184 and system components in this figure are exemplary and other systems may comprise other types and other combinations of devices.

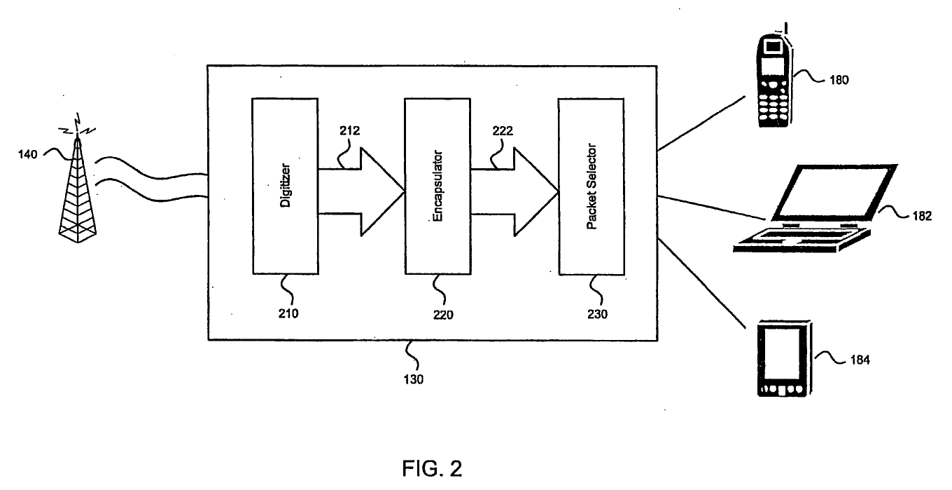

Embodiments of the steps involved in the distribution of data by media bridge 130 are depicted in more detail in FIG. 2. Content coming from media source 140 which is to be delivered to a device 180 may be in an analog format. This analog content, such as a television signal, radio broadcasts or video game data, may be captured using automatic or manual capture methods, and converted to a digital signal (STEP 210). One of ordinary skill in the art will understand the many and varied ways to accomplish this capture and analog to digital conversion (STEP 210). In one embodiment, raw TV signal 140 may be connected to a TV tuner capture card, which in turn captures incoming analog TV signal 140. This analog signal 140 may be converted to a digital signal via the use of a standard analog to digital converter of the type that are well known in the art.

The resulting digital data 212 may be converted to a variety of formats and encapsulated in packets (STEP 220) in order to facilitate delivery of data 212 to device 180. Packets of this data 222 may then be selected for delivery (STEP 230) to device 180 based upon a set of criteria, including requests from mobile device 180.

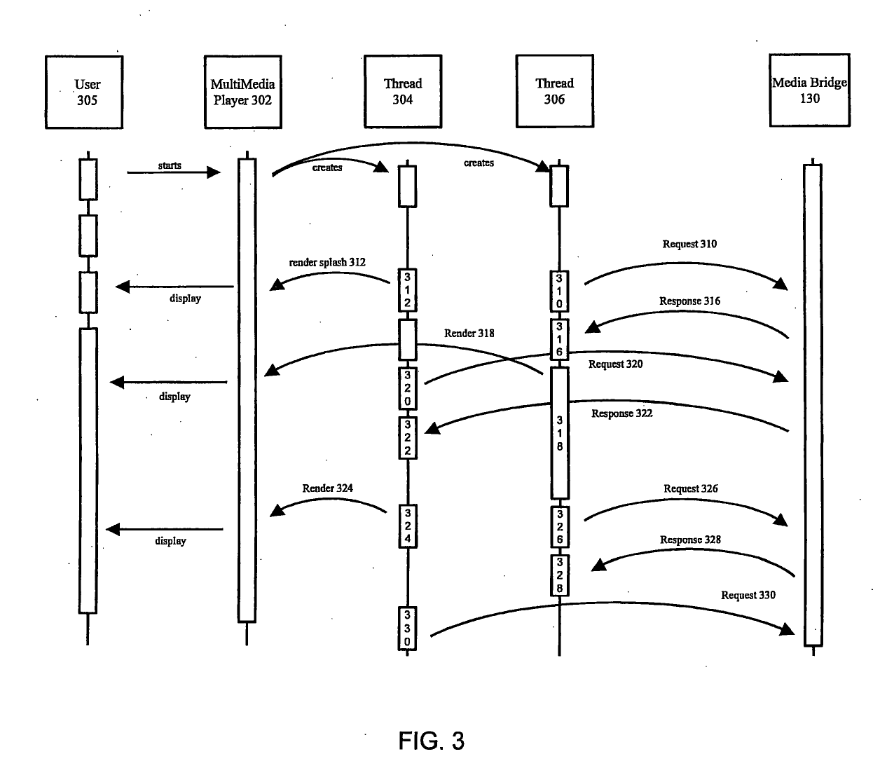

Moving now to FIG. 3, one embodiment of an architecture for requesting, receiving and displaying multimedia content at a mobile device is depicted. A user 305 at mobile device 180 may wish to receive or play some form of multimedia content, and open multimedia player 302. Multimedia player 302 may in turn instantiate threads 304 and 306.

Threads 304, 306 are responsible for reading data from media bridge 130 and rendering this data for display to user 305. In one embodiment, threads 304, 306 may be executing identical program code and operate in parallel. Threads 304, 306 neither both render nor both read simultaneously, when one thread is rendering data the other thread is rendering data and vice versa. If one thread finishes its phase before the other thread has completed its current phase, then the first thread waits for the second thread to finish before they swap roles. Thus, at any given time each thread 304, 306 is reading, rendering, waiting to read or waiting to render. Each thread 304, 306 may have its own buffer to which it writes data received from media bridge 130 and from which it reads data to render for display to user 305.

To synchronize threads 304, 306, many thread synchronization techniques may be utilized as is known in the art, such as semaphores, busy waiting, mutexes, java synchronized calls, etc. In one embodiment, synchronization between threads 304, 306 may be accomplished using a pair of global mutexes shared between threads 304, 306, one a read mutex for creating a critical section around the reading portion of the program code and one a render mutex for creating a critical section around the rendering portion of the program code. The following is exemplary pseudo code for each thread 304, 306, including the above discussed critical sections:

Global mutexRead;
Global mutexRender;
ThreadLocal Buffer buff;

while (ContinuePlaying( )){

| // read phase | |
|---|---|
| mutexRead.Lock( ); | |
| ReadData(buff); | // Read data into buffer |

| mutexRead.Unlock( ); | |
|---|---|
| // render phase | |
| mutexRender.Lock( ); | |
| m_canvas.RenderData(buff); | //Render data from buffer |
| mutexRender.Unlock( ); | |

}

In another embodiment, when the code to be executed by
threads 304, 306 is written in Java, object
synchronization can be used to create the critical
sections using a “synchronized” function call, as for
example:

Global mutexRead;
Global mutexRender;
ThreadLocal Buffer buff;

while (ContinuePlaying( )){

synchronized(mutexRead){

| | |
|---|---|
| ReadData(buff); | // Read data into buffer |

}
synchronized(mutexRender){

| | |
|---|---|
| RenderData(buff); | // Render data from buffer |

}

}

Returning to FIG. 3, multimedia player 302 may instantiate threads 304 and 306 which are identical, or executing identical code, as described above. Upon initialization, one thread 306 will lock the read mutex and send a request (request 310) to media server, while other thread 304 will be blocking waiting for thread 306 to finish reading. In one embodiment, thread 304 renders a preloaded data set (render 312) such as a splash screen, etc. upon initialization.

Thread 306 receives a packet (response 316) of data from media bridge 130, writing this packet to its buffer. Thread 306 may then unlock the read mutex. Once thread 306 unlocks the read mutex, thread 306 may lock the render mutex and begin rendering the data in its buffer (render 318). Substantially simultaneously, thread 304 may lock the read mutex and send a request (request 320) to media bridge 130. When a response to this request (request 320) is received (response 322) thread 304 may write this response to its buffer and unlock the read mutex.

After unlocking the read mutex, thread 304 may then attempt to lock the render mutex in order to render the data in its buffer. Suppose, however, that thread 306 has not yet finished rendering its data (render 318) and still has the render mutex lock. In this case, thread 304 will block trying to lock the render mutex. Eventually, thread 306 will finish rendering its data (render 318), unlocking the render mutex. Thread 304 can then unblock, lock the render mutex and render data from its buffer (render 324), while thread 306 may lock the read mutex and send a request for data (request 326) to media bridge 130.

Now suppose thread 304 finishes rendering its data (render 324), unlocks the render mutex, and attempts to lock the read mutex in order to read data from media bridge 130. Thread 306, however, has not finished reading (request 326, response 328) and still has the read mutex locked. Here, thread 304 will block trying to lock the read mutex. Eventually, thread 306 will finish reading its data (response 328), writing the data to its buffer and unlocking the read mutex. Thread 304 can then unblock, lock the read mutex and read data from media bridge 130 (request 330).

It will be apparent to those of skill in the art the permutations that may occur with respect to threads 304, 306, the read mutex, and the render mutex. For example, if thread 304 is rendering data, thread 306 is either reading data from media bridge 130 or blocking waiting to obtain the lock on the render mutex. Conversely, if thread 304 is reading data from media bridge 130, thread 306 is either rendering data or blocking waiting to obtain the lock on the read mutex. Similarly, if thread 306 is rendering data, thread 304 is either reading data from media bridge 130 or blocking waiting to obtain the lock on the render mutex; and if thread 306 is reading data from media bridge 130, thread 304 is either rendering data or blocking waiting to obtain the lock on the read mutex.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for receiving and processing data, comprising: providing a first thread and a second thread, wherein each thread is operable to read data and render data; and synchronizing the first thread and second thread so that while the first thread is rendering data the second thread is reading data or waiting to render data and while the first thread is reading data the second thread is rendering data or waiting to read data.

2. The method of claim 1, wherein synchronizing the first thread and second thread further comprises synchronizing the first thread and second thread so that while the second thread is rendering data the first thread is reading data or waiting to render data and while the second thread is reading data the first thread is rendering data or waiting to read data.

3. The method of claim 2, wherein the first thread and second thread execute identical program code.

4. The method of claim 3, wherein each thread has a buffer, and each thread reads data to its buffer and renders data from its buffer.

5. The method of claim 4, wherein the first thread and second thread are synchronized with a first mutex and a second mutex.

6. The method of claim 5, wherein the first mutex is a read mutex and the second mutex is a render mutex.

7. The method of claim 6, wherein the first mutex and second mutex are globally shared by the first thread and the second thread.

8. The method of claim 4, wherein the first thread and second thread are synchronized with a Java “synchronized” function call.

9. The method of claim 4, wherein the first thread and second thread are synchronized with a semaphore.

10. The method of claim 4, wherein the first thread and second thread are synchronized with busy waiting.

11. A computer readable medium, having instructions embodied thereon for receiving and processing data, the instructions translatable for:
providing a first thread and a second thread, wherein each thread is operable to read data and render data; and
synchronizing the first thread and second thread so that while the first thread is rendering data the second thread is reading data or waiting to render data and while the first thread is reading data the second thread is rendering data or waiting to read data.

12. The computer readable medium of claim 11, wherein synchronizing the first thread and second thread further comprises synchronizing the first thread and second thread so that while the second thread is rendering data the first thread is reading data or waiting to render data and while the second thread is reading data the first thread is rendering data or waiting to read data.

13. The computer readable medium of claim 12, wherein the first thread and second thread execute identical program code.

14. The computer readable medium of claim 13, wherein each thread has a buffer, and each thread reads data to its buffer and renders data from its buffer.

15. The computer readable medium of claim 4, wherein the first thread and second thread are synchronized with a first mutex and a second mutex.

16. The computer readable medium of claim 15, wherein the first mutex is a read mutex and the second mutex is a render mutex.

17. The computer readable medium of claim 16, wherein the first mutex and second mutex are globally shared by the first thread and the second thread.

18. The computer readable medium of claim 14, wherein the first thread and second thread are synchronized with a Java “synchronized” function call.

19. The computer readable medium of claim 14, wherein the first thread and second thread are synchronized with a semaphore.

20. The computer readable medium of claim 14, wherein the first thread and second thread are synchronized with busy waiting.

21. A system for a receiving and processing data, comprising:
a first thread; and
a second thread, wherein: each thread is operable to read data and render data; and the first thread and second thread are synchronized so that while the first thread is rendering data the second thread is reading data or waiting to render data and while the first thread is reading data the second thread is rendering data or waiting to read data.

22. The system of claim 21, wherein the first thread and second thread are further synchronized so that while the second thread is rendering data the first thread is reading data or waiting to render data and while the second thread is reading data the first thread is rendering data or waiting to read data.

23. The system of claim 22, wherein the first thread and second thread execute identical program code.

24. The system of claim 23, wherein each thread has a buffer, and each thread reads data to its buffer and renders data from its buffer.

25. The system of claim 24, wherein the first thread and second thread are synchronized with a first mutex and a second mutex.

26. The system of claim 25, wherein the first mutex is a read mutex and the second mutex is a render mutex.

27. The system of claim 26, wherein the first mutex and second mutex are globally shared by the first thread and the second thread.

28. The system of claim 24, wherein the first thread and second thread are synchronized with a Java “synchronized” function call.

29. The system of claim 24, wherein the first thread and second thread are synchronized with a semaphore.

30. The system of claim 24, wherein the first thread and second thread are synchronized with busy waiting.
